(19) United States
(12) Patent Application Publication
(10) Pub. No.: US 2022/0403897 A1
(43) Pub. Date: Dec. 22, 2022

(54) MAGNETORHEOLOGICAL BRAKE DEVICE, IN PARTICULAR AN OPERATING DEVICE

(71) Applicant: INVENTUS Engineering GmbH, St. Anton i.M (AT)

(72) Inventor: Stefan Battlogg, St. Anton i.M. (AT)

(21) Appl. No.: 17/772,355

(22) PCT Filed: Oct. 31, 2020
(86) PCT No.: PCT/EP2020/080613

§ 371 Date: Apr. 27, 2022

(30) Foreign Application Priority Data
Oct. 31, 2019 (DE) 10 2019 129 548.3
Dec. 18, 2019 (DE) 10 2019 135 030.1

(51) Int. Cl. F16D 57/00; G05G 5/03

(52) U.S. Cl. CPC F16D 57/002; G05G 5/03; F16D 2121/20

(57) ABSTRACT

A magnetorheological brake device for adjusting operating states by way of rotational movements includes an axle unit and a rotary body that can be rotated relative to the axle unit. A torque for the rotation of the rotary body can be varied in a targeted manner by a magnetorheological brake. A sensor device functions to detect a rotational position of the rotary body and includes a magnet ring unit and a magnet field sensor rotationally fixed to the axle unit and arranged radially and/or axially next to the magnet ring unit. The magnet field sensor is also arranged at least partially within the axle unit.

The present invention concerns a magnetorheological brake device for varying a torque of rotational movements, and in particular a magnetorheological operating device for adjusting operating states at least by means of rotational movements. The braking device comprises at least one axle unit and at least one rotary body which is rotatable relative to the axle unit. A torque for the rotatability of the rotary body can be adjusted in targeted fashion by means of at least one magnetorheological braking apparatus.

Such brake devices allow a particularly targeted deceleration as far as blocking of rotational movements. In some cases, the brake devices are configured as operating devices. Such operating devices are used more and more frequently in widely varying appliances, and their applications include e.g. motor vehicles (e.g. operating element in the center console, in the steering wheel, in the seat etc.), medical technology (e.g. for adjusting medical devices), or smart devices (e.g. Smartphone, Smartwatch, computer peripheral, computer mouse, game controller, joystick), off-highway vehicles (e.g. operating elements in agricultural machines), boats/ships and aircraft, in order for example to select from menus or also to be able to make precise adjustments. By means of the magnetorheological brake device, for example different moments, stop points and latches for the rotational movement can be set. Thus a particular feel can be achieved in the adjustment of operating states (haptic feedback) which supports the user and allows very precise settings and hence reduces operating complexity.

In order to be able to actuate the magnetorheological brake device in targeted fashion, usually a sensor device is provided for monitoring the rotary position. However, its structural accommodation in the brake device entails substantial difficulties.

Thus the sensor device (e.g. distance from the magnetic ring to the sensor) must usually be arranged within a very narrow tolerance band relative to the components to be monitored. For example, deviations in the distances of such components lead to a deterioration in the measurement signal and disruptive noise. This is of particularly great disadvantage for fine latching, reversal of rotation direction with stop, or blocking in a rotational direction (clockwise or counterclockwise), and for precise adjustment options (e.g. sensor with 90,112 increments). Also, because of the usually numerous components concerned, there are many interfaces with a long tolerance chain and hence a high total tolerance.

Further problems arise because of the usually extremely small dimensions of the brake device. Thus for example, for a brake device configured as a thumb roller, often only 12 mm diameter is available, as used for example in a wheel (roller) rotatable with one finger (e.g. thumb) on a steering wheel or a steering wheel spoke of e.g. a motor vehicle. Thus the installation space for the sensor device is very limited. As a whole, this leads to a need for optimization in terms of assembly, cost and installation space.

In this context, it is the object of the present invention to provide an improved brake device. In particular, the structural accommodation (installation space requirement, arrangement of components, total tolerance of components etc.) of the sensor device is improved. Here, preferably, a reliable sensor detection which is as precise as possible, at the same time as space-saving integration in the magnetorheological brake device, is possible.

This object is achieved by a brake device with the features of claim 1. Preferred refinements of the invention are the subject of the subclaims. Further advantages and features of the present invention arise from the general description and the description of exemplary embodiments.

The brake device according to the invention is magnetorheological and serves for varying a torque of rotational movements and/or for decelerating rotational movements. The brake device is in particular a magnetorheological operating device for adjusting operating states at least by means of rotational movements. The brake device comprises at least one axle unit. The brake device comprises at least one rotary body. The rotary body is rotatable relative to the axle unit and/or rotatable about the axle unit. A torque for the rotatability of the rotary body (relative to the axle unit) can be adjusted in targeted fashion by means of at least one magnetorheological braking apparatus. In particular, the rotatability of the rotary body can be decelerated and/or blocked in targeted fashion by means of the braking apparatus. The brake device comprises at least one sensor device at least for detecting a rotary position of the rotary body, in particular relative to the axle unit. Here, the sensor device comprises at least one magnetic field sensor which is rotationally fixedly connected to the axle unit. In particular, the magnetic field sensor is arranged radially and/or axially next to at least one magnetic ring unit. In particular, the sensor device comprises at least one magnetic ring unit. In particular, the magnetic field sensor is arranged (at least partially or substantially or completely) inside the axle unit.

The brake device according to the invention offers many advantages. One substantial advantage is offered by the arrangement of the magnetic field sensor. In this way, a space-saving accommodation is possible with a particularly short tolerance chain of the components (low total tolerance or few components between the sensor fixing and the magnet fixing) and at the same time a particularly reliable sensor detection. The connection of the magnetic field sensor to the axle unit offers a particularly tolerance-optimized integration. Also, the arrangement of the magnetic field sensor according to the invention offers substantial advantages in the use of the available installation space. This is of great advantage for example in the case of particularly compact finger rollers or mouse wheels. Also, with the invention, a particularly effective and also simple shielding of the sensor from the magnetic fields of the braking apparatus can be achieved.

In particular, the axle unit comprises at least one axle portion which at least in portions radially surrounds the magnetic field sensor. In particular, the magnetic field sensor is arranged (at least partially and in particular mainly and preferably completely) inside the axle portion. In particular, the axial portion has at least one radial (in particular tube-like) wall which at least partially provides the axle portion.

It is particularly preferred and advantageous if the axle portion has a lower magnetic conductivity than a core which, in particular, cooperates with an electrical coil of the braking apparatus. In this way, firstly the magnetic field sensor is not undesirably shielded from the magnetic field of the magnetic ring unit. Secondly, the magnetic field sensor may also be thereby protected particularly simply and effectively against an undesirable influence of the magnetic field of the braking apparatus.

In particular, the core is made of a magnetically conductive material or comprises at least one such material. The core is in particular made of a ferromagnetic material. In particular, the core has a relative permeability of more than 1 and preferably more than 10, and particularly preferably more than 100 or more than 1000.

In particular, the axle portion has a relative permeability of less than 10 and preferably less than 2 and particularly preferably less than 1. In particular, the axle portion is made from a magnetically non-conductive material or comprises at least one such material. The axle portion is in particular made from a paramagnetic material and/or a diamagnetic material. In particular, the axle portion is made from a plastic. It is possible that the entire axle unit is formed in this way, e.g. made of plastic. Then the core is preferably configured separately and attached or connected to the axle unit.

In particular, the axle unit provides a support structure for attaching the brake device and/or comprises at least one such structure. In particular, the at least one braking apparatus can be attached to the axle unit. In particular, the rotary body is rotatably mounted on the axle unit (by means of at least one bearing device). The axle portion preferably provides at least one supporting part of the axle unit. The axle portion is in particular an axial portion of the axle unit.

It is possible and advantageous for the axle unit to be made of multiple pieces. In particular, the axle unit then comprises at least two axle portions, namely the at least one (first) axle portion and at least one further axle portion. In particular, the further axle portion has a higher magnetic conductivity than the (one or first) axle portion. The further axle portion preferably provides or is part of the core.

The axial portions may be oriented axially and/or radially to one another. In particular, the further axial portion axially adjoins the (one or first) axle portion. Thus the further axle portion may at least partially radially surround the axle portion. In particular, the axle portion and the further axle portion (or all axle portions) are fixedly connected together so that they preferably form the supporting axle unit. For example, the axle portions may be bolted and/or bonded and/or joined together in another suitable fashion.

Preferably, the axle portion and the core are (fixedly) connected together. In particular, the axle portion and the core together form the axle unit or at least a (in particular supporting) part of the axle unit. It is however also possible that the (first) axle portion forms the axle unit or a supporting part of the axle unit, and the further axle portion, in particular the core, is supported by the (first) axle portion.

The axle unit may also comprise at least three axle portions. In particular, the core then provides a middle axle portion which is axially enclosed by at least a (first) axle portion and at least a third axle portion.

The axle unit may also be configured integrally. Then the axle portion is in particular an integral part of the axle unit which in particular cannot be released non-destructively. In particular, the core then forms a separate part of the axle unit which is preferably at least indirectly attachable thereto. Particularly preferably, the axle unit is then formed as a holder which, as well as the supporting axle function, also comprises a receiver device for the core and/or the coil.

In particular, the core is arranged adjacent to the (first) axle portion in an axial direction. In particular, at least one electrical coil (coil unit) is arranged and preferably wound around the core and/or inside the core. In particular, the electrical coil is wound around the core in the axial direction and in particular spans a coil plane so that a magnetic field of the electrical coil extends transversely to the longitudinal axis of the axle unit (through the axle unit). Additionally or alternatively, the electrical coil may be wound in the radial direction around the core and in particular span a coil plane, so that a magnetic field of the electrical coil extends along or parallel to the longitudinal axis of the axle unit.

Preferably, the rotary body is configured as a finger roller and particularly preferably as a thumb roller. Preferably, the rotary body is configured as a cylindrical component which is set in rotation by means of at least one finger. In particular, the brake device is provided for operation with just one finger. In particular, the brake device is suitable and configured for operation in a horizontal position. In particular, the rotational axis of the rotary body assumes a position which is more horizontal than vertical. It is however also possible that the brake device can be operated upright (vertical orientation). Here, the brake device is in particular usually held by two or more fingers. The rotary body may also be configured as a rotary knob or similar, and in particular include at least one push function and/or pull function. This push/pull function may be used for example to select or confirm certain menu options.

In particular, the rotary body or finger roller has a diameter of less than 50 mm and preferably less than 20 mm, and particularly preferably less than 15 mm. For example, the rotary body has a diameter of maximum 12 mm. However larger or smaller diameters for the rotary body are possible and advantageous for certain applications.

It is possible that the rotary body is surrounded by at least one additional part to increase the diameter. The additional part is for example configured as a ring or similar. The additional part may be provided with at least one contour to improve haptic feel, and in particular may be fluted and/or rubberized or similar.

The magnetic ring unit is preferably arranged on an axial end face of the rotary body. This offers a particularly advantageous accommodation of the magnetic ring unit. The magnetic ring unit may be attached directly to the axial end face. It is however also possible that the magnetic ring unit is attached to the axial end face of the rotary body via at least one connecting element. It is also possible that the magnetic ring unit is arranged on the axial end face of the rotary body and attached via corresponding connecting elements at another position of the brake device.

It is preferred and advantageous if at least portions of the magnetic ring unit surround the magnetic field sensor in the manner of a ring. In particular, the magnetic ring unit is arranged radially around the magnetic field sensor. In particular, the magnetic ring unit is arranged at least partially (preferably completely) outside the axle unit. In particular, the magnetic ring unit surrounds the axle portion of the axle unit. In particular, the magnetic field sensor is arranged centered to the magnetic ring unit in the axial direction. This means that the magnetic field sensor is arranged at the same axial longitudinal position as the magnetic ring unit. The magnetic field sensor may however also be offset to the magnetic ring unit in the axial direction. In the context of the present invention, such positional data and in particular the terms “radial” and “axial” in particular refer to the rotational axis of the rotary body.

It is also preferred and advantageous if the magnetic ring unit and the magnetic field sensor are arranged coaxially to one another. This offers a particularly space-saving accommodation also for particularly small dimensions and for example in a thumb roller. In particular, the magnetic field sensor is here surrounded by the magnetic ring unit. The magnetic field sensor is in particular centered axially and/or radially to the magnetic ring unit. In particular, the magnetic field sensor has a targeted radial offset from the rotational axis of the magnetic ring unit. The magnetic field sensor may also be arranged offset to the magnetic ring unit in the axial direction.

It may be provided that the magnetic field sensor is arranged offset from the rotational axis of the magnetic ring unit. This may also be provided when, as a whole, a central arrangement for the magnetic field sensor is provided, for example if the magnetic field sensor is arranged inside the axle unit and surrounded by the magnetic ring unit in the manner of a ring. A targeted offset of the magnetic field sensor relative to the rotational axis of the magnetic ring unit allows an improved rotary angle measurement. Thus for example, even with only two poles of the magnetic ring unit, each rotary position can be precisely defined and hence every angle measured as accurately as possible. Thus an absolute value emitter can be implemented particularly simply.

In a particularly preferred embodiment, the magnetic field sensor is arranged inside the axle unit. This offers a particularly compact while also tolerance-optimized accommodation of the magnetic field sensor. The axle unit for this in particular has at least one bore in which the magnetic field sensor is arranged. In particular, the bore runs inside the axle portion. In the context of the present invention, a bore means in particular also all suitable other recesses and/or passage openings, irrespective of whether or not these are produced by means of a boring process. The bore in particular runs in the longitudinal direction of the axle unit. The bore is in particular designed so as to be continuous, or it may also be formed as a blind hole.

In particular, the magnetic field sensor is arranged centrally in the axle unit. In particular, at least one active sensor portion of the magnetic field sensor is arranged inside the axle unit. Preferably, the entire magnetic field sensor is arranged inside the axle unit. It is possible that the magnetic field sensor is attached inside and/or outside the axle unit. In particular, at least one fixing portion of the magnetic field sensor is arranged inside and/or outside the axle unit. In the context of the present invention, the positional data for the magnetic field sensor in particular also refer to at least the active sensor portion.

The magnetic field sensor is preferably arranged in the bore of the axle unit through which an electrical connection of the braking apparatus also runs. The electrical connection here comprises in particular at least one supply line and/or control line for the coil unit. This offers an advantageous use of installation space and also allows a particularly simple transmission of the sensor signals. In particular, the electrical connection emerges from the axle unit on the end face.

The magnetic field sensor is in particular arranged on at least one circuit board. The circuit board is for example a printed circuit board or comprises at least one such circuit board. Preferably, also at least the braking apparatus, in particular the coil unit, is electrically connected to the circuit board. Preferably, also at least one connecting line for contacting the brake device is connected to the circuit board. It is preferred and advantageous that the circuit board is arranged inside the axle unit. It is also preferred that the connecting line extends out of the axle unit.

In particular, the circuit board is here arranged in the above-described bore. In particular, the connecting line runs through the bore. In particular, the connecting line emerges from the axle unit at an end face. This offers a particularly simple and rapid installation and also compact accommodation of the corresponding components.

The connecting line in particular comprises at least one plug connector unit. For example, a plug connector unit with six or eight pins is provided. Thus the brake device may be connected particularly quickly and also reliably to the components to be operated and for example to a vehicle electronic system. By plugging in the plug connector, the operating unit may also be fixed in the mounting position (e.g. holder of the operating part).

Preferably, the magnetic field sensor is cast into the axle unit and/or encased by at least one material. In particular, for this the bore is at least partially filled with the material. Particularly preferably, the circuit board is encased by at least one material in the axle unit. Preferably, a plastic or other suitable material is provided. Thus the magnetic field sensor or the circuit board may be reliably protected from external influences and also attached in a simple fashion.

In an advantageous embodiment, the magnetic field sensor is arranged on an end face of an axial end of the axle unit, and particularly preferably centered on the end face. Here, the magnetic field sensor is at least partially arranged inside the axle unit. This accommodation offers advantages with respect to both sensor quality and also installation complexity and space requirement. In particular, the magnetic field sensor is arranged on the end face of the axle unit which is arranged inside the rotary body. Here, the magnetic ring unit is preferably arranged outside the rotary body. The magnetic ring unit may however also be arranged inside the rotary body. In such an embodiment, the magnetic field sensor may be arranged offset to the magnetic ring unit in relation to the axial direction. The magnetic field sensor may however also be provided at the same axial longitudinal position as the magnetic ring unit.

In particular, the magnetic field sensor is attached directly onto and/or in the axle unit. For example, the magnetic field sensor may be connected to the axle unit by means of an encasing molding or similar. It is however also possible that the magnetic field sensor is attached to the axle unit by means of at least one connecting structure. The magnetic field sensor may also be at least partially set back into the end face of the axle unit. It may also be provided that the magnetic field sensor is arranged radially on an axial end of the axle unit.

In particular, at least portions of the magnetic ring unit surround the axle unit in the manner of a ring. In particular, the magnetic ring unit is arranged radially around the axle unit. In particular, the magnetic ring unit is arranged thus with respect to the longitudinal direction of the axle unit. In particular, the magnetic ring unit and the axle unit are assigned to one another in a coaxial fashion. Here, the axle unit is preferably in the center of the arrangement.

In an advantageous and preferred refinement, the magnetic field sensor is arranged at least partially between the magnetic ring unit and the axle unit. In particular, the magnetic field sensor is then arranged radially inside the magnetic ring unit. In particular, the magnetic ring unit then surrounds the magnetic field sensor in the manner of a ring.

It is preferred that the rotary body is rotatably mounted on the axle unit by means of at least one bearing device. For example, the bearing device comprises at least one roller bearing and/or plain bearing and/or at least one bearing of another suitable design.

The braking apparatus preferably comprises at least one wedge bearing device. At least one wedge bearing device may also be assigned to the braking apparatus. The wedge bearing device in particular comprises at least one and preferably a plurality of roller bodies. These may be cylindrical and/or spherical roller bodies. The wedge bearing device is in particular here configured as a roller bearing or comprises at least one such bearing.

The braking apparatus is in particular suitable and configured for damping and/or decelerating and/or blocking the rotatability of the rotary body in targeted fashion by means of the wedge bearing device and the coil unit and the magnetorheological medium. The braking apparatus is in particular suitable and configured for reducing, again in targeted fashion and by means of the wedge bearing device and the coil unit and the magnetorheological medium, a moment for the rotatability of the rotary body after a deceleration or blocking.

Here, the wedge bearing device, in particular its roller bearings and preferably its roller bodies, is preferably arranged axially between the magnetic ring unit and the braking apparatus, in particular a coil unit of the braking apparatus. This gives a particularly advantageous spacing of the magnetic ring unit from the magnetic field of the coil unit.

The damping takes place in particular via the so-called wedge effect which has been disclosed in earlier patent applications from the applicant (for example in DE 10 2018 200 390.0). For this, roller bodies in the rotary body lie next to the coil unit and axle unit. The roller bodies are surrounded by a magnetorheological fluid. The magnetic field of the coil unit passes through the roller bodies via the housing of the rotary body and closes via the axle unit. Here, wedges form in the magnetorheological fluid which brake the movement of the roller bodies and hence of the rotary body. The roller bodies may be balls, cylindrical rollers or other parts.

The magnetic field sensor is in particular arranged axially between the wedge bearing device and the magnetic ring unit. The magnetic field sensor may also be arranged axially between the coil unit and the magnetic ring unit.

The magnetic ring unit is in particular arranged axially between the wedge bearing device and the magnetic field sensor. The magnetic ring unit may be arranged axially between the coil unit and the magnetic field sensor. Such designs allow a compact structure and also an advantageous detection quality.

It is possible that the magnetic field sensor and/or the magnetic ring unit are arranged on the end face of the rotary body which also lies on an end face of the axle unit from which at least one signal line of the magnetic field sensor emerges, so that the signal line does not run through a magnetic field of the braking apparatus. This has the advantage that the signals from the magnetic field sensor are not disrupted by the magnetic field of the coil device. In particular, also the connecting line of the brake device is arranged on this end face. The end face means in particular an axial end region.

It is also possible that the magnetic field sensor and in particular also the magnetic ring unit are arranged on the end face of the rotary body which lies opposite an end face of the axle unit from which at least one signal line of the magnetic field sensor emerges. In such an embodiment, a signal transmission in the signal line takes place preferably optically. Thus the signals from the magnetic field sensor are not unfavorably disrupted despite passing through the magnetic field of the coil device. In particular, the signal transmission takes place optically at least at the point where the signal line runs through the magnetic field of the coil device. In particular, the signal line comprises or is configured at least in portions at least one light wave guide. In particular, the signal line runs at least in portions through the bore in the axle unit.

Preferably, the signal line is provided at least in portions by at least one bore in the axle unit. Preferably, the axle unit itself serves as a light wave guide. The bore is in particular the above-described bore. In such a design, the magnetic field sensor is in particular arranged on the end face of the axle unit or inside the axle unit.

In all embodiments, it is particularly preferred that the magnetic ring unit and/or the magnetic field sensor are arranged inside a (radial) circumferential line delimited by the rotary body. In particular, the magnetic ring unit and/or the magnetic field sensor do not protrude beyond the (radial) circumference of the rotary body. In particular, the magnetic ring unit and/or the magnetic field sensor do not protrude beyond a radius of the rotary body. In particular, the magnetic ring unit and the magnetic field sensor are arranged radially inside the circumferential line of the rotary body. In particular, the circumferential line is delimited by the rotary body itself and not by an additional part arranged on the rotary body.

It is possible that the magnetic ring unit is arranged outside a receiving chamber delimited by the rotary body. Here, in particular, at least one sealing device is arranged between the magnetic ring unit and the rotary body. In particular, this sealing device bears sealingly on the rotary body and the axle unit in order to prevent the emergence of a magnetorheological medium arranged in the receiving chamber. The sealing device comprises in particular at least one sealing portion which bears on the axle unit. The sealing device comprises in particular at least one sealing portion which bears on the rotary body. The sealing device comprises at least one slide seal or is configured as such. It is however also possible that the magnetic ring unit is arranged inside the receiving chamber.

Preferably, at least one in particular magnetically conductive wall is arranged between the magnetic ring unit and the braking apparatus, in particular its coil unit. In particular, the wall is suitable and configured for shielding a magnetic field of the magnetic ring unit such that it does not scatter into the braking apparatus and/or the receiving chamber and thereby unfavorably influence the magnetorheological medium.

In particular, for this the wall comprises or consists of a ferromagnetic and/or paramagnetic material. The wall may also comprise or consist of a diamagnetic material. It is possible that the rotary body and/or the core are also made of such a material. For example, the material is a nickel-iron alloy with e.g. 69-82% nickel. Other metals shielding the magnetic field are also possible (so-called p metals). In particular, the wall has a relative magnetic permeability of at least 1000 and preferably at least 10,000 and particularly preferably at least 100,000 or at least 500,000.

The wall is preferably provided at least partially by an end wall of the rotary body. This is in particular a closed end wall through which the axle unit does not extend. Then the wall is in particular formed integrally with the rotary body.

It is also possible and preferred that the wall at least partially closes an open end face of the rotary body. Then it is preferred that the axle unit extends through the wall. Then the wall in particular has at least one passage opening for the axle unit. It is also possible and advantageous that the wall is configured as a support structure for the sealing device. In particular, at least one sealing portion for the axle unit and one for the rotary body are attached to the wall. In such designs, the wall is in particular attached to the axle unit.

It is possible that the magnetic field sensor is arranged inside a receiving chamber delimited by the rotary body. The rotary body in particular provides a receiving chamber. In particular, the magnetic field sensor is separated at least by means of a sealing unit from a magnetorheological medium arranged in the receiving chamber. The sealing unit in particular comprises at least one sealing ring (O-ring) or similar running radially around the axle unit. The sealing unit in particular bears sealingly on the rotary body and axle unit. It is preferred that the magnetic field sensor is separated from the magnetorheological medium by means of at least one wall of the axle unit.

In particular, the magnetic field sensor is then arranged at least partially in an end face bulge of the rotary body. In particular, the magnetic ring unit then lies outside the rotary body. The bulge is in particular centered on the end face. In such an embodiment, the magnetic field sensor is in particular arranged in and/or on the end face of the axle unit. The bulge is in particular arranged on the end face of the rotary body from which the axle unit does not emerge. The magnetic field sensor may also be arranged outside the rotary body.

It is possible and preferred that the magnetic field sensor is configured and suitable for detecting, in addition to the rotary position, also at least one axial position of the rotary body relative to the axle unit. In particular, the magnetic field sensor is then configured as a three-dimensional magnetic field sensor. In particular, the axial position is detected by means of the magnetic ring unit. In particular, the axial position is detected by means of an axial position of the magnetic ring unit relative to the magnetic field sensor. Such an embodiment is particularly advantageous for a brake device in which also the operating states are adjusted by means of pressing and pulling movements. In particular, the brake device is suitable and configured for adjusting operating states also by means of at least one pressing movement. The pressing movement takes place in particular in the direction of the rotational axis for the rotational movement of the rotary body.

In an advantageous refinement, the magnetic field sensor comprises at least two sensor units. In particular, the sensor units are arranged radially next to one another. Preferably, the sensor units are arranged radially about a common center. The center lies in particular in a longitudinal axis or rotational axis of the axle unit. In this way, the measurement result can be substantially improved. It is possible that the sensor units are arranged on a common circuit board. Here, the sensor units are arranged concentrically around the circuit board. In particular, the sensor units each comprise at least one active sensor portion. In particular, the sensor units are radially surrounded by a common magnetic ring unit.

In particular, the rotary body is rotatable about the axle unit. In particular, the axle unit is configured so as to be stationary. In particular, the axle unit provides a support structure for components received thereon, and in particular for the rotary body mounted thereon and/or for the braking apparatus and/or for the sensor device. It may be provided that, when the brake device is in the correctly mounted state, the axle unit is attached to at least one bracket or similar. In particular, the axle unit comprises or is configured as at least one axle, in particular a hollow axle. In particular, a (theoretical) longitudinal axis of the axle unit provides the (theoretical) rotational axis of the rotary body. In particular, the axle unit and the rotary body are arranged coaxially to one another.

It is also possible that the axle unit is rotatable or forms the rotating part, and the rotary body surrounding the axle is configured so as to be stationary. In particular, the axle unit is then rotatably received in the rotary body. The axle unit may then also be described as a shaft.

The electrical connection of the (magnetic field) sensor then preferably is not implemented via cables or wires, but via contacts which are movable relative to one another and not fixedly coupled together, and e.g. via sliding contacts. The electrical connection of the (magnetic field) sensor may also be implemented wirelessly, and for example by inductive energy and data transmission and/or optical transmission and/or radio transmission, such as e.g. Wlan, Bluetooth etc. The electrical connection of the magnetic field sensor may also be implemented via a spiral spring and/or a flexible cable. This is advantageous if no or only one or only a few complete rotations are provided. In particular, the at least one signal line of the magnetic field sensor is configured in this way. It is possible that also the electrical contacting of the braking apparatus (in particular the electrical coil) is configured in this way, e.g. by means of inductive current transmission.

The rotary body is in particular configured as a sleeve and in particular consists of magnetically conductive material. In particular, the rotary body comprises or is configured as at least one rotary sleeve. The rotary body is in particular configured as a rotary knob. In particular, the rotary body is cylindrical. The rotary body in particular has two end faces and a cylindrical wall extending in between. Here, the rotary body preferably comprises at least one closed end face. It is also possible that both end faces are at least partially closed. In particular, the rotary body is formed integrally, wherein in particular the cylindrical wall is integrally connected to at least one end wall.

In particular, the axle unit extends into the rotary body and preferably into its receiving chamber. In particular, the rotary body is configured and arranged on the axle unit such that the axle unit extends out of the rotary body at an open end face. Here, in particular, the other end face of the rotary body is closed.

The braking device in particular comprises at least one actuatable coil unit for generating a targeted magnetic field. The braking apparatus and preferably at least the coil unit are in particular rotationally fixedly arranged on the axle unit.

The braking apparatus in particular comprises at least one magnetorheological medium. The medium is in particular a fluid which preferably comprises a liquid as a carrier for particles. In particular, magnetic and preferably ferromagnetic particles are present in the fluid. It is also possible that the medium contains only particles and there is no carrier medium (vacuum).

In particular, the braking apparatus may be actuated depending on at least one signal detected by the sensor device. Preferably, a control device is provided for actuating the braking apparatus depending on the sensor device. In particular, the control device is suitable and configured for generating a targeted magnetic field with the coil unit depending on the signal from the sensor device. The braking apparatus is in particular also a damper device.

In particular, at least one receiving chamber is provided for the medium. In particular, the receiving chamber is provided by the rotary body. It is possible that further components are arranged in the receiving chamber, including for example the wedge bearing device and/or the coil unit and/or the magnetic field sensor and/or the magnetic ring unit. It is possible that the receiving chamber is divided into mutually sealed part chambers. Preferably, one part chamber is provided for the magnetorheological medium. In particular, the magnetic field sensor is arranged in another part chamber or not in the part chamber with the medium.

In particular, the brake device, in particular the braking apparatus, comprises at least one wedge bearing device and preferably at least one roller bearing. In particular, the wedge bearing device, preferably its roller bodies, is (directly) surrounded by the medium. Preferably, the brake device comprises at least one sealing device and/or at least one sealing unit in order to prevent the emergence of medium from the receiving chamber. In particular, the receiving chamber is sealed against the rotary body and the axle unit. The wedge bearing device surrounds the axle unit in particular radially.

The sensor device is in particular configured as an absolute value emitter. The sensor device may also be configured as an incremental emitter or as another suitable design. The sensor device is in particular actively connected to the control device and/or the braking apparatus.

The magnetic ring unit is in particular formed closed in the manner of a ring. The magnetic ring unit may also be formed open in the manner of a ring. In particular, the magnetic ring unit comprises or is configured as at least one permanent magnet. In particular, the magnetic ring unit provides at least one magnetic north pole and at least one magnetic south pole. In particular, at least one shielding device is assigned to the magnetic ring unit for shielding its magnetic field from the magnetic field of the coil unit. The shielding device in particular comprises or is provided by the above-described wall.

The magnetic field sensor is in particular suitable and configured for detecting the orientation of the magnetic field of the magnetic ring unit. In particular, the magnetic field sensor is configured as a Hall effect sensor (in particular 3-D Hall effect sensor) or comprises at least one such sensor. Other suitable sensor types for detecting the magnetic field of the magnetic ring unit are also possible.

A braking apparatus suitable for use with the invention is also described in patent application DE 10 2018 100 390.0. The entire disclosure of DE 10 2018 100 390.0 is hereby made part of the disclosure content of the present application.

In all embodiments, particularly preferably, at least one shielding device is provided for at least partial shielding of the sensor device from a magnetic field of a or the coil unit (electrical coil) of the braking apparatus. The shielding device comprises at least one shielding body surrounding the magnetic ring unit (at least in portions and in particular completely), and at least one separating unit arranged between the shielding body and the magnetic ring unit, and at least one magnetic decoupling device arranged between the shielding body and the rotary body. The separating unit and the decoupling device in particular have a magnetic conductivity which is many times smaller than that of the shielding body.

The shielding body is in particular not arranged between the magnetic field sensor and the magnetic ring unit, so that the shielding body does not shield the magnetic field sensor from the magnetic field of the magnetic ring unit to be detected.

Preferably, the shielding body at least in portions surrounds the magnetic ring unit at least on a radial outside, and/or the shielding body at least in portions surrounds the magnetic ring unit at least on at least one axial side facing the coil unit of the braking apparatus.

Preferably, the shielding body is configured as a shielding ring with an L-shaped or U-shaped cross-section.

The separating unit in particular comprises at least one gap running between the shielding body and the magnetic ring unit, and at least one filling medium arranged in the gap.

The filling medium preferably connects the magnetic ring unit rotationally fixedly to the shielding body.

The applicant reserves the right to claim a sensor apparatus which comprises at least one axle unit and at least one rotary body, rotatable relative to the axle unit, of at least one sensor device at least for detecting a rotary position of the rotary body. Here, the axle unit, the rotary body and the sensor device are configured as described herein for the brake device according to the invention.

Further advantages and features of the present invention arise from the description of the exemplary embodiments which are explained below with reference to the appended figures.

The figures show:

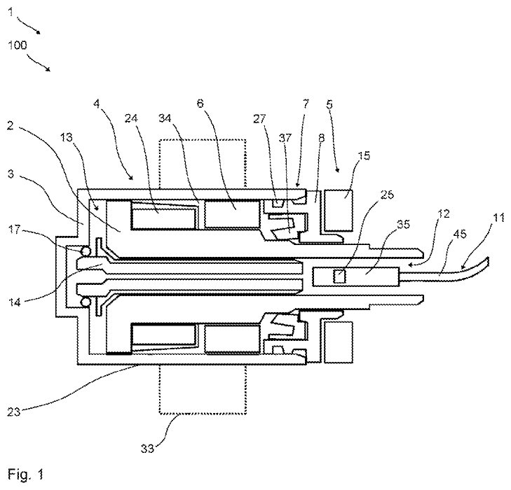

FIG. 1 a purely schematic illustration of a brake device according to the invention in a cut-away side view;

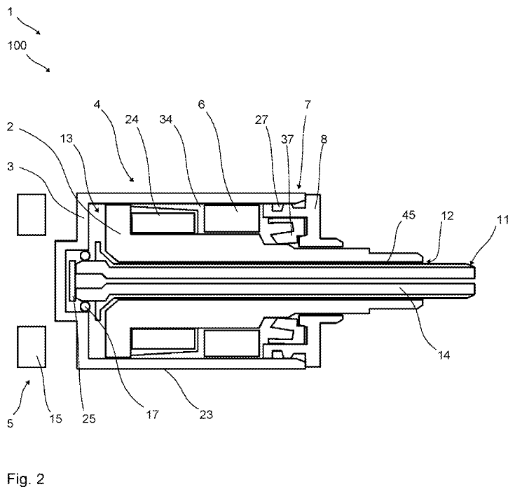

FIGS. 2-4 purely schematic illustrations of further embodiments of the brake device in cut-away side views;

FIG. 5 a purely schematic illustration of an axle unit of a brake device according to the invention in a cut-away side view;

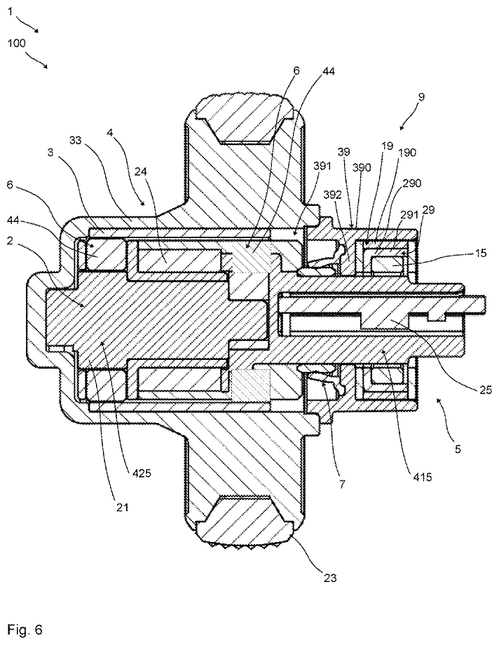

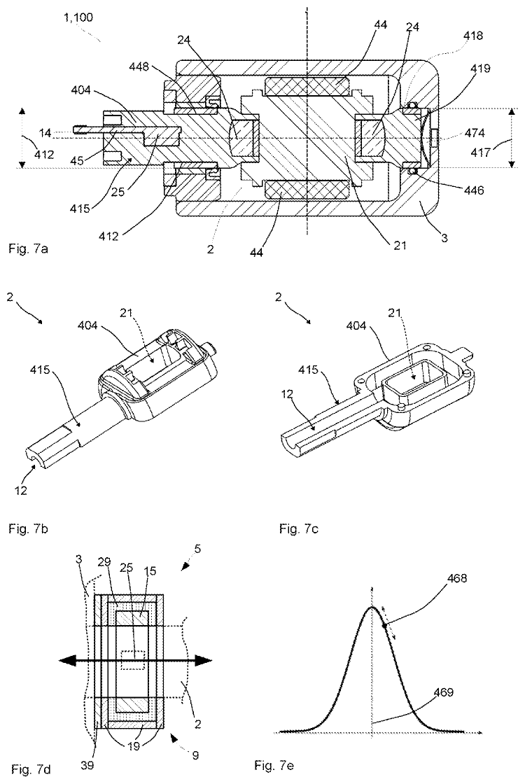

FIGS. 6-7a purely schematic illustrations of further brake devices in cut-away side views;

FIGS. 7b-7d detail views of the brake device from FIG. 7a;

FIG. 7e a schematic illustration of a development of a sensor signal; and

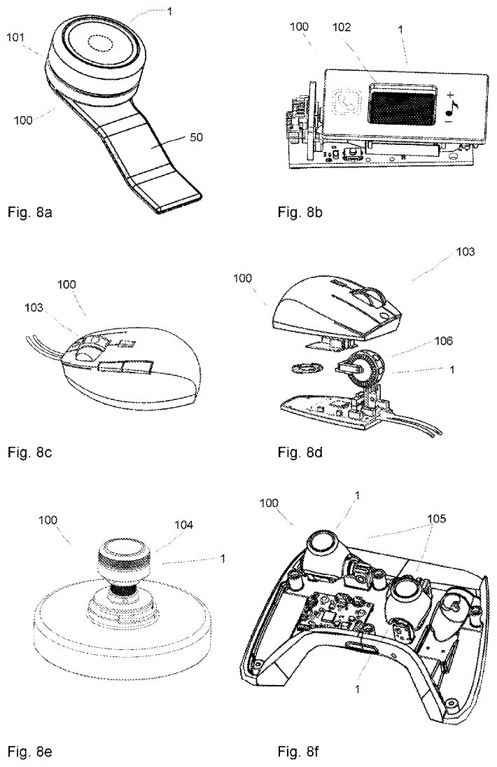

FIGS. 8a-8e schematic three-dimensional views of brake devices.

FIG. 1 shows a brake device 1 according to the invention which is here configured as an operating device 100 and has a rotatable rotary body 3, configured as a finger roller 23 or thumb roller 102, for adjusting operating states. Operation thus takes place here at least by turning the rotary body 3.

The rotary body 3 is here rotatably mounted on an axle unit 2 by means of a bearing device (not shown in detail here). The axle unit 2 here forms a first brake component 2 and the rotary body forms the second brake component 3. The rotary body 3 may also be rotatably mounted on an axle unit 2 by means of a wedge bearing device 6, here configured as a roller bearing. Preferably however, the wedge bearing device 6 is not or is only partially provided for the mounting 22 of the rotary body 3 on the axle unit 2, but serves for the braking apparatus 3 presented below. The roller bodies of the wedge bearing device 6 here serve as the braking bodies 44 described in more detail below.

The axle unit 2 may be mounted on an object to be operated and for example in an interior of a motor vehicle or on a medical device or Smart device. For this, the axle unit 2 may here comprise mounting means (not shown in detail).

It may be provided here that the rotary body 3 is also movable on the axle unit 2 in the longitudinal direction or along the rotational axis. Then operation takes place both by turning and by pressing and/or pulling or moving the rotary knob 3.

The rotary body 3 is here configured as a sleeve and comprises a cylindrical wall and an end wall integrally connected thereto. The axle unit 2 emerges from an open end side of the rotary body 3.

The finger roller 23 may be equipped with an additional part 33 (indicated here in dotted lines). This increases the diameter in order to facilitate rotatability, for example in the case of a wheel rotatable by one finger on a computer mouse 103 or game controller, in particular a game pad 105, or a rotary control on a computer keypad thumb roller 102.

The rotational movement of the rotary knob 3 is here damped by a magnetorheological braking apparatus 4 arranged in a receiving chamber 13 inside the rotary knob 3. A coil unit 24 of the braking apparatus 4 generates a magnetic field which acts on a magnetorheological medium 34 situated in the receiving chamber 13. This leads to a local strong cross-linking of magnetically polarizable particles in the medium 34. The braking apparatus 4 thereby achieves a targeted deceleration and even complete blocking, and in particular also a targeted release of the rotational movement. Thus with the braking apparatus 4, a haptic feedback during the rotational movement of the rotary body 3 can be achieved, for example by a correspondingly perceptible latching or by dynamically adjustable stops.

For supply and actuation of the coil unit 24, the braking apparatus 4 here comprises an electrical connection 14 which is configured for example in the manner of a circuit board 35 or printed circuit board or cable line. The connecting line 11 here extends through a bore 12 running in the longitudinal direction of the axle unit 2.

The receiving chamber 13 is here sealed towards the outside by a sealing device 7 and a sealing unit 17 in order to prevent an emergence of the medium 34. The medium 34 is here a magnetorheological medium 34. The sealing device 7 here closes the open end face of the rotary body 3. For this, a first sealing part 27 bears on the inside of the rotary body 3. A second sealing part 37 bears on the axle unit 3. The sealing parts 27, 37 are here attached to and/or configured as a support structure configured as a wall 8.

The sealing unit 17 is here configured as an O-ring and radially surrounds the axle unit 3. The sealing unit 17 lies against the axle unit 2 and the rotary body 3. In this way, the part of the receiving chamber 13 filled with the medium 34 is sealed against another part of the receiving chamber 13.

In order to monitor the rotary position of the rotary body 3 so as to be able to actuate the braking apparatus 4, here a sensor device 5 is provided. The sensor device 5 comprises a magnetic ring unit 15 and a magnetic field sensor 25.

The magnetic ring unit 15 is here diametrically polarized and has a north pole and a south pole. The magnetic field sensor 25, here configured as a Hall effect sensor, measures the magnetic field emitted by the magnetic ring unit 15 and thus allows reliable determination of the rotary angle.

Also, the magnetic field sensor 25 is here preferably configured three-dimensionally, so that in addition to rotation, an axial movement of the rotary body 3 relative to the axle unit 2 can be measured. In this way, both the rotation and a pushbutton function (push/pull) can be measured simultaneously with the same magnetic field sensor 25. The brake device 1 may however also be equipped with just a rotational function.

The sensor device 5 is particularly advantageously integrated in the brake device 1. For this, the magnetic field sensor 25 is here inserted in the bore 12 of the axle unit 2. The magnetic ring unit 15 radially surrounds the magnetic field sensor 25 and is attached to the rotary body 3. This has the advantage that no length tolerances apply, but only precisely producible diameter tolerances. The radial bearing gap between the rotating rotary body 3 and the stationary axle unit 2 is correspondingly small and also easily managed in mass production.

A further advantage is that axial movements or displacements between the rotary body 3 and the axle unit 2 do not unfavorably influence the sensor signal, since measurements are made in the radial direction and it is the radial distance which is substantially decisive for the quality of the measurement signal.

It is a further advantage that the arrangement shown here is particularly non-sensitive to dirt and liquids since the sensor is arranged on the inside. Also, the magnetic field sensor 25 in the bore 12 may for example be encased in a plastic.

In order to further improve the accommodation of the magnetic field sensor 25, this is here arranged on a circuit board 35 or printed circuit board. Here, the coil unit 24 or its connection 14 is also contacted on the circuit board 35.

Furthermore, the connecting line 11, via which the entire brake device is connected to the system to be operated, is also attached to the circuit board 35. Thus for example a 6-pin or 8-pin plug connector may be attached to the circuit board 35, via which both the magnetic field sensor 25 and the coil unit 24 can be connected to the corresponding controller. Here, the signal line 45 for transmitting the sensor signal is also arranged in the connecting line 11.

Thus the brake device 1 can be installed particularly easily and quickly. In order to make the entire system particularly robust against faults and disturbance, the circuit board 35 may be cast in the bore 12 and the magnetic field sensor 25 in the axle unit 2.

FIG. 2 shows an embodiment of the brake device 1 which differs from the embodiment described above substantially in the structural accommodation of the sensor device 5. Here, the magnetic ring unit 15 is arranged on the end face of the rotary body 3 which is closed or through which the axle unit 2 does not extend.

Here, a particularly space-saving accommodation for the magnetic field sensor 25 inside the axle unit and inside the rotary body 3 is provided. For this, the magnetic field sensor 25 is arranged with an active sensor part in the receiving chamber 13. Another part of the magnetic field sensor 25 extends into the axle unit 2 where it is attached. The magnetic field sensor 25 lies in the part of the receiving chamber 13 which is separated from the part with the medium 34 by the sealing unit 17. Here, this part of the receiving chamber 13 lies in a central bulge of the rotary body 3. The magnetic field sensor 25 is here attached to an end face of the axle unit 2.

The axially offset positioning of the magnetic ring unit 15 is here shown highly schematically, and this may for example also lie more closely against the rotary body 3 so that the magnetic ring unit 15 surrounds the magnetic field sensor 25 in the manner of a ring.

In the embodiment shown here, the magnetic field sensor 25 is arranged on the end face of the rotary body 3 which lies opposite the outlet side for the signal line 45 or connecting line 11. Therefore, here the sensor signal is conducted through the bore 12 in the axle unit 2 to the opposite side and must therefore pass through the magnetic field of the coil unit 24.

In order to avoid disruption of the signal, the signal transmission here takes place optically. For this, the light signal is here simply radiated through the bore 12 of the axle unit 2. It may however also be provided that the signal line 45 is configured as a light wave guide at least in the region of the coil unit 24. For sending and receiving signals, corresponding photodiodes (not shown in detail here) are provided.

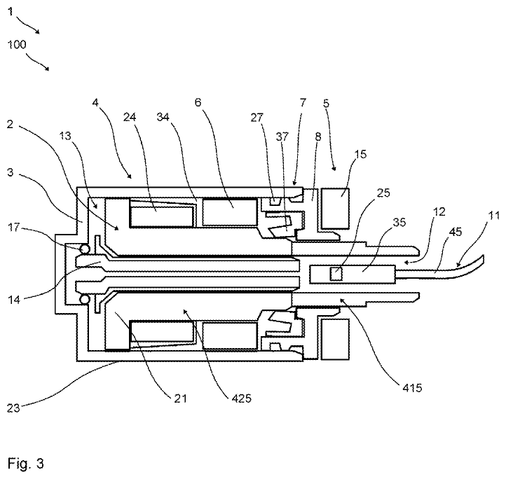

FIG. 3 shows an embodiment which differs from the embodiments previously described substantially in structural design of the axle unit 2. Here, the axle unit 2 comprises an axle portion 415 which radially surrounds the magnetic field sensor 25. The axle portion 415 has a lower magnetic conductivity than a core 21, which here carries a winding of the electrical coil 24 of the braking apparatus 4. Thus the magnetic field of the magnetic ring unit 15 can penetrate the axle unit 2 particularly well in the region of the magnetic field sensor 25, so that an improved sensor resolution is possible.

Here, the core 21 provides a supporting second axle portion 425 of the axle unit 2. For this, the axle portions 415, 425 are here fixedly connected together and e.g. screwed together. The axle portions 415, 425 are here dimensioned such that the sealing part 37 bears on the core 21. Since the core 21 here consists of a harder material than the axle portion 415, any running of the sealing part 37 onto the axle unit 2 is reliably avoided.

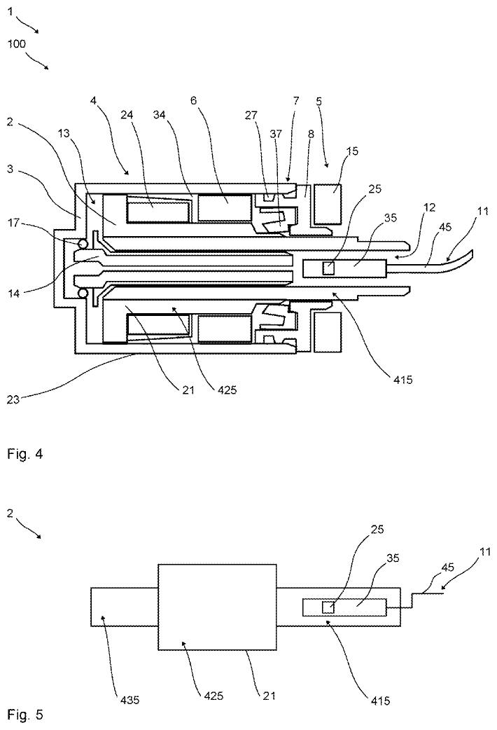

FIG. 4 shows an embodiment of the axle unit 2 in which the second axle portion 425 radially surrounds the first axle portion 415 in portions. The second axle portion 425 is here again provided by the core 21 for the coil 24. The first axle portion 415 is formed exposed in the axial region of the magnetic field sensor 25. So the magnetic field sensor 25 is there not shielded by the core 21. In the region of the braking apparatus 4, the second axle portion 425 or the core 21 then radially surrounds the first axle portion 415. In this way, the core 21 can be mounted particularly simply.

In the embodiments shown in FIGS. 1 to 4, the wall 8 is configured so as to be magnetically conductive. This may prevent the magnetic field of the magnetic ring unit 15 and the magnetic field of the coil unit 24 from unfavorably influencing one another. For example, the wall 8 is made of a metal which shields a magnetic field, and for example from a metal with a relative magnetic permeability of at least 100,000. For example, the wall 8 is made of a nickel-iron alloy. At the same time, the wall 8 here serves as a connection for the sealing device 7. In order to shield the magnetic field of the magnetic ring unit 15 shown in FIG. 2 from the magnetic field of the coil unit 24, there the end face of the rotary body 3 is made of a magnetically conductive material.

FIG. 5 shows a detail illustration of an axle unit 2 which here consists of three axle portions 415, 425, 435. A first axle portion 415 serves as a receiver for the magnetic field sensor 25, and for this is designed as described before with reference to FIGS. 3 and 4. Connected to this is a second axle portion 425 which is formed by the core 21. Adjoining this is a third axle portion 435 which forms the axial end of the axle unit 2. Thus for example the rotary body 3 may be attached to the third axle portion 435. It is also possible that a further core 21 adjoins the third axle portion 435. Thus a correspondingly extensive magnetic field can be produced with a strong braking effect.

FIG. 6 shows a brake device according to the invention with a shielding device 9 for shielding the sensor device 5 from the magnetic field of the coil unit 24 of the braking apparatus 4. The brake device 1 shown here differs from the brake devices 1 described above not only in the shielding device 9 but in particular also by the design of the rotary body 3 and the additional part 33. The brake device 1 shown here is for example a mouse wheel 106 of a computer mouse 103 or a finger roller 23 or a thumb roller 102.

The rotary body 3 is here configured as a cylindrical sleeve and on its outside is completely surrounded by the additional part 33. The additional part 33 here terminates the rotary body 3 at the radial end face which faces away from the magnetic ring unit 15.

The additional part 33 has a radially circumferential protrusion with a substantially enlarged diameter. This makes the brake device 1 shown here particularly suitable for a mouse wheel 106 of a computer mouse 103 or similar. The protrusion is here configured with a groove in which a particularly grippy material, e.g. rubber, is embedded.

The brake device 1 shown here has two wedge bearing devices 6 spaced apart from one another. The wedge bearing devices 6 are each equipped with several braking bodies 44 arranged radially around the axle unit 2. The coil unit 24 is arranged between the wedge bearing devices 6. The braking bodies 44 are here for example roller bodies which roll on the inside of the rotary body 3 or on the outside of the axle unit 2, or are arranged there, and have a slight and in particular minimal distance from the outside of the axle unit.

The magnetic ring unit 15 is coupled rotationally fixedly to the rotary body 3 so that the magnetic ring unit 15 co-rotates on rotation of the rotary body 3. The magnetic field sensor 25 is here inserted in the bore 12 of the axle unit 2. The magnetic ring unit 15 surrounds the magnetic field sensor 25 radially and is arranged axially on the end. The magnetic field sensor 25 is here arranged with an axial offset from the axial center of the magnetic ring unit 15. This gives a particularly high-resolution, reproducible sensing of the axial position of the rotary body 3 relative to the axle unit 2.

The shielding device 9 comprises a shielding body 19, here configured as a shielding ring 190. The shielding device 9 also comprises a separating unit 29 which is here provided by a gap 290 filled with a filling medium 291. Also, the shielding device 9 comprises a magnetic decoupling device 39 which is here provided by a decoupling sleeve 390 and a decoupling gap 391.

The decoupling sleeve 190 here comprises an axial wall 392 on which the sealing device 7 is arranged. Also, a bearing device 22 (not shown here in detail) may be arranged on the axial wall 392.

The shielding body 19 here has an L-shaped cross section and is made of a magnetically particularly conductive material. The shielding body 19 surrounds the magnetic ring unit 15 on its radial outside and on its axial side facing the coil unit 24. For magnetic decoupling, the gap 290 is arranged between the shielding body 19 and the magnetic ring unit 15 and filled with a filling medium 291. The filling medium 291 has a particularly low magnetic conductivity. Also, the magnetic ring unit 15 is attached to the shielding body 19 via the filling medium 291.

A magnetic decoupling between the rotary body 3 and the shielding body 19 is achieved by the decoupling device 39. For this, the decoupling sleeve 390 and a filling medium 291, arranged in the decoupling gap 391, also have a particularly low magnetic conductivity. The decoupling sleeve 391 is here rotationally fixedly connected to the shielding body 19 and the additional part 33 and the rotary body 3.

In order to achieve an even better decoupling of the rotary body 3 from the sensor device 5, the rotary body 3 is here arranged axially spaced from the decoupling sleeve 390. The end of the rotary body 3 facing the magnetic ring unit 15 here does not protrude beyond the braking body 44. Also, the rotary body 3 is axially set back or shortened relative to the additional part 33. This gives a particularly advantageous magnetic and physical separation of the rotary body 3 and decoupling sleeve 390 in a very small installation space.

Since the magnetic field of the coil unit 24 for the braking effect flows via the rotary body 3, such an embodiment offers a particularly good shielding. So that this magnetic flux has as little influence as possible on the magnetic field sensor 25, the rotary body 3 terminates earlier in the axial direction and the magnetically non-conductive additional part 33 takes over the structural functions (bearing point, sealing points etc.). The distance from the magnetic field sensor 25 is thereby even greater and the assembly as a whole is lighter.

The rotary body 3 is made from a magnetically particularly conductive material. The additional part 33 and the decoupling sleeve 390 are however made of a magnetically non-conductive material. The shielding body 19 and the rotary body 3 are here made for example from a p metal. The components described here as magnetically non-conductive consist for example of plastic and have a relative magnetic permeability of less than 10.

The problematic fields which can often disrupt the rotary angle measurement are above all the fields in the radial direction. These fields are here shielded by a shielding body 19 of suitable material, e.g. magnetically conductive steel, acting as a jacket. In addition, the magnetic field of the magnetic ring unit 15 may thus be further amplified. As a result, the magnetic ring unit 15 may be made smaller (thinner) and hence material, installation volume and production costs can be saved.

The construction according to the invention is improved in that the wall thickness of the shielding body 19 is varied, and a gap 290 is provided between the magnetic ring unit 15 and the shielding body 19. The shielding and the amplification may be optimally adapted by the gap 290 between the magnetic ring unit 15 and the shielding body 19. The material of the shielding body 19 is here selected such that it does not go into magnetic saturation, so external magnetic fields can be adequately shielded (material in saturation allows the passage of magnetic fields in the same way as air, i.e. with a magnetic field constant of μ0). With an advantageous design of the gap 290 between the magnetic ring unit 15 and the shielding body 19, the magnetic field does not close too strongly via the shielding body 19, and the field in the center with the magnetic field sensor 25 is sufficiently homogenous and is increased compared with a magnetic ring unit 15 of the same or larger size without shielding body 19.

The dimensioning of the shielding device 9 shown here is particularly suitable for a mouse wheel 106 of a computer mouse 103, and for example has the following dimensions. The shielding ring 190 is 0.5 mm thick, the distance between the shielding ring 190 and the magnetic ring unit 15 is also 0.5 mm, the width of the magnetic ring unit 15 is 2 mm, and the diameter of the magnetic ring unit 15 is 8 mm. In this case, the possible interference field of the coil unit 24 is 140 μT, giving a possible error in angular measurement of 0.1° (cf Earth's magnetic field: approximately 48 μT in Europe).

FIG. 7a shows a variant in which a push-pull function is integrated. A button 474 may be actuated and is automatically reset. The diameters of the two bearing points 412, 418 are here selected to be the same size. As a result, on an axial movement of the first brake component 2 (corresponding to the axle unit) relative to the second brake component 3 (corresponding to the rotary body), the volume inside the chamber does not change. A movement of the first brake component 2 to the left in the orientation of FIG. 7a leads to an increase or change in the distance of the magnetic field sensor 25 from the magnetic ring unit 15.

An axial movement causes a change in the signal 468 received, as illustrated in FIG. 7e. FIG. 7e shows the curve of the amplitude 469 of the signal 468 detected by the magnetic field sensor 25 as a function of the axial movement of the brake components 2, 3 (horizontal axis). An axial movement of the magnetic field sensor 25 relative to the magnetic ring unit 15 changes the amplitude 469 of the detected signal 468. An axial movement or pressing down of the additional part 33, or a sideways movement of the additional part 33, can thus be detected. The same magnetic field sensor 25 can also detect the rotary angle, wherein to detect the rotary angle, the direction of the magnetic field is determined. The intensity determines the axial position. Therefore, a change in the signal 468 indicates an axial actuation of the brake device 1 or button 474. This is advantageous since a single (multi-dimensional) Hall effect sensor can be used for determining the angular position and for determining an axial position.

In FIG. 7a, the first brake component 2 is arranged inside the second brake component 3, and is held by form fit and/or force fit by a holder 404. The holder 404 may for example be attached to an external bracket or a device. The holder 404 is usually attached rotationally fixedly. The second brake component 3 is received on the first brake component 2 so as to be continuously rotatable relative thereto.

The bracket 404, as shown in FIGS. 7b and 7c, may preferably be formed in two pieces. This simplifies above all installation of the electrical lines and in particular of the sensor line 45 inside the first brake component 2. The cables can be laid through the here open cable passage or bore 12. FIG. 7d shows the sensor device 3 again in detail. The first brake component 2 and the second brake component 3, here configured as a rotary part, are merely indicated (dotted lines). The sensor device 5 here rests via the decoupling device 39 on the rotatable second brake component 3 in a magnetically decoupled fashion. The shielding device 9 here consists of a three-piece shielding body 19. In addition, a separating unit 29 is also provided for magnetic separation. The magnetic ring unit 15 is used for measuring the orientation or rotary angle of the magnetorheological braking apparatus 1. The magnetic field sensor 25 is arranged inside the first brake component 2. Small relative axial movements can also be used to detect e.g. when an operating knob 101 is pressed down.

FIGS. 8a to 8f show devices which are equipped with the invention. The brake devices 1 here are each configured as haptic operating devices 100.

FIG. 8a shows a haptic operating knob 101. The operating knob is attached via a bracket 50. The operating knob 101 is here operated via the sleeve part. The user interface may also be used to transmit information.

In FIG. 8b, the brake device 1 is formed as a thumb roller 102 with haptic operating device 100. The thumb roller 102 can preferably be used for example in steering wheels. The thumb roller 102 is not however restricted to this application. The thumb roller 102 may in general also be usable with another finger depending on installation situation.

FIGS. 8c and 8d show the brake device 1 according to the invention as a mouse wheel 106 of a computer mouse 103. The magnetorheological brake device 1 may be used to control a haptic feedback.

FIG. 8e shows a joystick 104 with a brake device 1 as a haptic operating device 100. FIG. 8f shows a game pad 105 with the brake device 1 in order to give the player a haptic feedback depending on the game situation.

The preferably low-alloy steel may retain a residual magnetic field. The steel is preferably demagnetized regularly or as required (e.g. by a special alternating field).

Preferably, the material FeSi3P (silicon steel) or a related material is used for the components through which the magnetic field flows.

In all cases, a voice control or sound control may also be implemented. The braking apparatus may be adaptively controlled by voice control.

If the rotary unit is not being turned, i.e. the angle is constant, preferably the current is continuously reduced over time. The current may also be varied speed-dependently (rotary angular speed of rotary unit).

The principle of the sensor structure presented is not restricted to purely magnetorheological rotary dampers, but may also be applied to any device with rotatable parts in which a particularly advantageous measurement of the rotary angle is desired.

### LIST OF REFERENCE SIGNS

1 Brake device
2 Axle unit
3 Rotary body
4 Braking apparatus
5 Sensor device
6 Wedge bearing device
7 Sealing device
8 Wall
9 Shielding device
11 Connecting line
12 Bore
13 Receiving chamber
14 Connection
15 Magnetic ring unit
17 Sealing unit
19 Shielding body
21 Core
22 Bearing device
23 Finger roller
24 Coil unit
25 Magnetic field sensor
27 Sealing part
29 Separating unit
33 Additional part
34 Medium
35 Circuit board
37 Sealing part
39 Decoupling device
44 Braking body
45 Signal line
50 Bracket
100 Operating device
101 Operating knob
102 Thumb roller
103 Computer mouse
104 Joystick
105 Game pad
106 Mouse wheel
190 Shielding ring
226 Latching point
228 End stop
229 End stop
237 Angular distance
238 Stop moment
239 Latching moment
240 Base moment
290 Gap
291 Filling medium
390 Decoupling sleeve
391 Decoupling gap
392 Axial wall
404 Holder
412 Bearing point
415 Axle portion
416 Diameter
417 Diameter
418 Bearing point
425 Axle portion
435 Axle portion
448 Slide ring guide
468 Signal
469 Amplitude
474 Button

1-19. (canceled)

20. A magnetorheological brake device, comprising:
an axle unit and a rotary body rotatably mounted relative to said axle unit;
a magnetorheological braking apparatus configured to selectively adjust a torque for a rotatability of said rotary body;
a sensor device disposed to detect a rotary position of said rotary body, said sensor device including at least one magnetic ring unit and at least one magnetic field sensor arranged radially and/or axially next to said magnetic ring unit, said at least one magnetic field sensor being rotationally affixed to said axle unit and arranged at least partially inside said axle unit.

21. The magnetorheological brake device according to claim 20, wherein said axle unit comprises at least one axle portion which at least in portions radially surrounds said magnetic field sensor, and wherein the axial portion has a lower magnetic conductivity than a core cooperating with an electrical coil of said braking apparatus.

22. The magnetorheological brake device according to claim 20, wherein said magnetic ring unit is arranged on an axial end face of said rotary body.

23. The magnetorheological brake device according to claim 20, wherein at least portions of said magnetic ring unit surround at least one of said magnetic field sensor or said axle unit annularly.

24. The magnetorheological brake device according to claim 20, wherein said magnetic ring unit and said magnetic field sensor are arranged coaxially to one another.

25. The magnetorheological brake device according to claim 20, wherein said magnetic field sensor is arranged in a bore formed in said axle unit and wherein an electrical connection of said braking apparatus also runs through said bore.

26. The magnetorheological brake device according to claim 20, wherein said magnetic field sensor is arranged on a circuit board, said braking apparatus is electrically connected to said circuit board, wherein at least one connecting line for contacting said brake device is connected to said circuit board, and said circuit board is arranged inside said axle unit and the connecting line extends out of said axle unit.

27. The magnetorheological brake device according to claim 20, wherein said magnetic field sensor is encased with potting material in said axle unit, and/or wherein said circuit board is encased with potting material in said axle unit.

28. The magnetorheological brake device according to claim 20, wherein at least portions of said magnetic ring unit surround said axle unit in a ring shape.

29. The magnetorheological brake device according to claim 20, which further comprises at least one wedge bearing device configured to selectively decelerate or block said rotary body, wherein said wedge bearing device is arranged axially between said magnetic ring unit and a coil unit of said braking apparatus.

30. The magnetorheological brake device according to claim 20, wherein at least one of said magnetic field sensor or said magnetic ring unit is arranged on an end face of said rotary body which also lies on an end face of said axle unit from which at least one signal line of said magnetic field sensor emerges, wherein the signal line does not run through a magnetic field of said braking apparatus.

31. The magnetorheological brake device according to claim 20, wherein said magnetic field sensor and said magnetic ring unit are arranged on an end face of said rotary body opposite an end face of said axle unit from which at least one signal line of said magnetic field sensor emerges, and wherein the signal line is an optical line for optical signal transmission.

32. The magnetorheological brake device according to claim 31, wherein the signal line is, at least in portions, formed by a bore in said axle unit so that said axle unit itself serves as a light wave guide.

33. The magnetorheological brake device according to claim 20, wherein at least one of said magnetic ring unit or said magnetic field sensor is arranged inside a radial circumferential line delimited by said rotary body.

34. The magnetorheological brake device according to claim 20, wherein said magnetic ring unit is arranged outside a receiving chamber delimited by said rotary body, and wherein at least one sealing device is arranged between said magnetic ring unit and said rotary body, which bears sealingly on said rotary body and said axle unit in order to prevent a magnetorheological medium to leak from said receiving chamber.

35. The magnetorheological brake device according to claim 20, which comprises a magnetically conductive wall arranged between said magnetic ring unit and said braking apparatus.

36. The magnetorheological brake device according to claim 35, wherein said wall is at least partially provided by an end wall of said rotary body, and/or wherein said wall at least partially closes an open end face of said rotary body, and/or wherein said wall is configured as a support structure for said sealing device.

37. The magnetorheological brake device according to claim 20, wherein said magnetic field sensor is arranged inside a receiving chamber delimited by said rotary body, and wherein said magnetic field sensor is separated by a sealing unit from a magnetorheological medium arranged in said receiving chamber.

38. The magnetorheological brake device according to claim 20, wherein said magnetic field sensor is configured for detecting the rotary position of said rotary body and an axial position of said rotary body relative to said axle unit.

39. The magnetorheological brake device according to claim 20 in a magnetorheological operating device for adjusting operating states by way of rotational movements via said rotary body.
